(19) United States
(12) Patent Application Publication
(10) Pub. No.: US 2009/0027583 A1
(43) Pub. Date: Jan. 29, 2009

(54) MAGNETIC-BASED VISUAL DISPLAY COVER ARRANGEMENT

(76) Inventors: Michael David McBroom, Celeste, TX (US); Daniel McBroom, Leonard, TX (US); Brian Thomas Sudderth, Leonard, TX (US); John Patrick Ternus, Redwood City, CA (US); Todd Gotham, Campbell, CA (US); Andrew Lauder, Santa Clara, CA (US)

Correspondence Address: IPSG, P.C., P.O. BOX 700640, SAN JOSE, CA, 95170-0640, US

(21) Appl. No.: 11/829,845

(22) Filed: Jul. 27, 2007

(51) Int. Cl. G02F 1/13; G06F 1/16

(52) U.S. Cl. 349/58

(57) ABSTRACT

A display housing for housing a display monitor is provided. The display housing includes an enclosure for enclosing at least a portion of the display monitor. The enclosure is non-ferrous and has a first side and a first magnetically attractable assembly coupled to the enclosure. The display housing also includes a non-opaque screen having a second side and a second magnetically attractable assembly coupled to the non-opaque screen such that when the second side of the non-opaque screen is mated with the first side of the enclosure, a magnetic attraction force is created between the first magnetically attractable assembly and the second magnetically attractable assembly. The first magnetically attractable assembly and the second magnetically attractable assembly are configured such that the magnetic attraction force is sufficiently strong to hold the non-opaque screen to the enclosure during use.

### BACKGROUND OF THE INVENTION

Advances in technology have proliferated the usage of computers. In order to display the electronic signals from the computer, a viewable display is required. The viewable display may be a separate equipment, such as a monitor. The viewable display may also be a component of the computer, such as an LCD screen on a laptop. In some models, all hardware components of the computer (such as processor, memory, IO, disk drives, etc) are implemented in an integrated manner with the display screen itself.

In recent years, covering the viewable display screen (e.g., monitor, LCD screen, etc.) with a transparent material has gained popularity. For some users, the transparent material is employed as a protective covering for the viewable display screen. The transparent material may also be available in different patterns and colors and may be employed as a decorative cover. Accordingly, some users are employing the decorative cover as a method for personalizing what some may view as an impersonal commodity.

The transparent material is usually attached to the viewable display screen by the manufacturer. The manufacturer may employ different methods for performing the attachment. To facilitate discussion, FIG. 1 shows an example of a simple block diagram of a monitor arrangement 100, representing a typical prior art monitor. Monitor arrangement 100 may include a viewable display screen, such as an LCD screen 102. Surrounding LCD screen 102 may be an enclosure 104, which may be made from a non-ferrous material such as aluminum. Located on top of LCD screen 102 is a transparent material, such as a glass screen 106. As previously mentioned, glass screen 106 is an optional covering that may be added to protect LCD screen 102 and/or to personalize monitor arrangement 100.

One way to attach glass screen 106 to monitor arrangement 100 is to employ an adhesive 108, such as an epoxy. In an example, adhesive 108 may be employed to affix glass screen 106 to enclosure 104. By affixing glass screen 106 to monitor arrangement 100 via an adhesive, a non-separable assembly is created. Unfortunately, since the assembly is non-separable, the task of removing glass screen 106 from monitor arrangement 100 in order to service the glass screen and/or the monitor arrangement may usually result in damage to glass screen 106.

In addition, the non-separable assembly of glass screen 106 to monitor arrangement 100 may create buckling. Buckling may occur when components of a device are made of materials that may react differently to environmental conditions, such as thermal expansion. In other words, dissimilar materials in a non-separable assembly may cause buckling. In an example, the heat emitted from the LCD screen may have a different affect on glass screen 106 in comparison to enclosure 104 since glass and aluminum may have different thermal expansion coefficient. Over time buckling may cause glass screen 106 to be offset in regard to LCD screen 102, resulting in an unattractive arrangement that may not provide the user with the protection and/or decorative requirement as originally envisioned. As a result, buckling may result in the need for a replacement of glass screen 106. As previously mentioned, since glass screen 106 is affixed to enclosure 104 via adhesive 108, servicing the glass screen may usually require the replacement of glass screen 106.

Buckling may be minimized by affixing glass screen 106 to enclosure 104 via a trapped arrangement. An example of a trapped arrangement may include attaching glass screen 106 to enclosure 104 via a set of screws. Another example of a trapped arrangement may include strapping glass screen 106 to monitor arrangement 100. Although the trapped arrangement may minimize buckling, the trapped arrangement provides an unattractive solution since the fixtures employed to affix glass screen 106 to enclosure 104 are usually not hidden. Thus, the cosmetic aspect of the transparent material can not be shown to its full advantage.

### BRIEF SUMMARY OF THE INVENTION

The invention relates, in an embodiment, to a display housing for housing a display monitor. The display housing includes an enclosure for enclosing at least a portion of the display monitor. The enclosure is non-ferrous and has a first side and a first magnetically attractable assembly coupled to the enclosure. The display housing also includes a non-opaque screen having a second side and a second magnetically attractable assembly coupled to the non-opaque screen such that when the second side of the non-opaque screen is mated with the first side of the enclosure, a magnetic attraction force is created between the first magnetically attractable assembly and the second magnetically attractable assembly. The first magnetically attractable assembly and the second magnetically attractable assembly are configured such that the magnetic attraction force is sufficiently strong to hold the non-opaque screen to the enclosure during use.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 shows an example of a simple block diagram of a monitor arrangement, representing a typical prior art monitor.

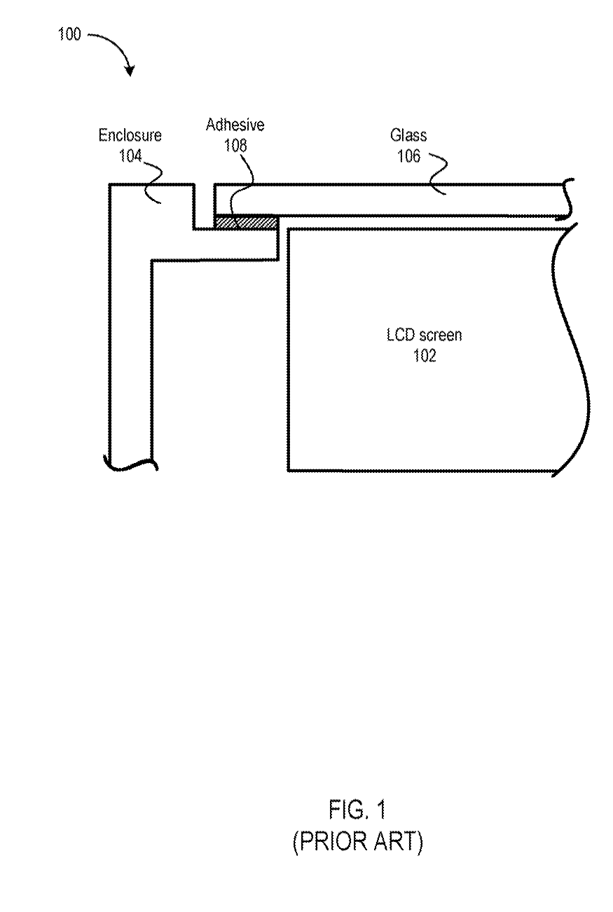

FIG. 2A shows, in an embodiment of the invention, a simple diagram illustrating a magnetic-based visual display cover arrangement.

FIG. 2B shows, in an embodiment of the invention, a cross-sectional view of a magnet-based monitor arrangement.

FIG. 2C shows, in an embodiment of the invention, a simple cross-sectional view of the coupling between magnet-based monitor arrangement and ferrous-based cover arrangement.

FIG. 2D show, in an embodiment of the invention, a simple cross-sectional view of alignment between the magnet-based monitor arrangement and the ferrous-based cover arrangement.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

The inventors herein realized that elegance may be provided in conjunction with durability and serviceability via a magnetic arrangement. In accordance with embodiments of the invention, a magnetic-based visual display cover arrangement is provided. In embodiments of the invention, the magnetic-based visual display cover arrangement may be a display housing. The display housing for housing a display monitor may include an enclosure having thereon (or coupled therewith) a magnetically attractable assembly. The display housing may also include a non-opaque screen having thereon (or coupled therewith) a counterpart magnetically attractable assembly. When the non-opaque screen is mated with the enclosure, the two magnetically attractable assemblies create a magnetic force sufficiently strong to hold the non-opaque screen to the enclosure during normal use, thereby eliminating the need for unsightly screws or glue or any other screen-to-enclosure attachment mechanism to keep the non-opaque screen attached to the enclosure during use.

As the term is employed herein, the enclosure-side magnetically attractable assembly may represent any component or plurality of components capable of being attracted magnetically to another ferrous or magnetic component. Examples of such magnetically attractable assembly include one or more ferrous components, one or more magnets, etc. Likewise, screen-side magnetically attractable assembly may represent any component or plurality of components capable of being attracted magnetically to another ferrous or magnetic component. Examples of such screen-side magnetically attractable assembly include one or more ferrous components, one or more magnets, etc. A non-opaque screen represents a screen that is not opaque to the human viewer when viewing from the typical display viewing position (i.e., from in front of the display screen). Examples of non-opaque screens include clear or colored or polarized screens. The screens themselves may be made of glass or plastic, for example.

In an embodiment of the invention, the enclosure-side magnetically attractable assembly may be a magnet-based monitor arrangement. The magnet-based monitor arrangement, in an embodiment, may include a set of magnets attached to a standard monitor arrangement, which may include a visual display screen surrounded by an enclosure. Examples of visual display screen may include, but are not limited to, an LCD screen, a plasma screen, and the like. The enclosure is a typical enclosure made from a non-ferrous material, such as aluminum.

The set of magnets may be discretely hidden from view by being affixed to the inside of the enclosure. In an embodiment, the set of magnets may be dispersed at different locations around the enclosure. In an embodiment, the set of magnets may be affixed to the enclosure by applying adhesive, such as epoxy. The non-ferrous characteristic of the enclosure and the adhesive enable the magnet force field emitted by the set of magnets to be controlled. In other words, the enclosure may provide a shield for the set of magnets without creating significant interference in the magnetic force field that may be generated by the set of magnets.

In an embodiment of the invention, the enclosure-side magnetically attractable assembly is attracted to the screen-side magnetically attractable assembly. In an embodiment, the screen-side magnetically attractable assembly is a ferrous-based cover arrangement. In an example, the magnet-based monitor arrangement is attracted to the ferrous characteristic of the ferrous-based cover arrangement. In an embodiment, the ferrous-based cover arrangement may include a ferrous component, such as a set of ring bands, attached to a non-opaque screen. A non-opaque screen represents a screen that is not opaque to the human viewer when viewing from the typical display viewing position (i.e., from in front of the display screen). Examples of non-opaque screens include clear or colored or polarized screens. The screens themselves may be made of glass or plastic, for example. In an embodiment, the set of ring bands may be made from ferrous-based materials, such as steel, iron, and the like.

In an embodiment, the set of ring bands may be a single ring band. In another embodiment, the set of ring bands may be a plurality of small ring bands distributed along the outer edges of the non-opaque screen. As can be appreciated from the foregoing, the number of ring bands that may be utilized may be based on a manufacturer's configuration preference.

In an embodiment, to enable coupling between the set of ring bands and the set of magnets, the set of ring bands may be strategically positioned. In other words, the set of ring bands may be aligned with the set of magnets when the ferrous-based cover arrangement is attached to the magnet-based monitor arrangement in order to take advantage of the attraction force between the set of ring bands and the set of magnets to create tension between the two arrangements. In an embodiment, the coupling strength between the two arrangements may be increased or decreased based on a manufacturer's configuration preferences. In an example, manufacturers may increase the coupling tension between the two arrangements by increasing the size of the set of magnets and/or size of the set of ring bands. In another example, the manufacturers may tune the magnetic force by increasing or decreasing the number of magnets being employed.

The tuning of the magnetic force may be performed to accommodate the different application of the magnetic-based visual display cover arrangement. In an example, the manufacturers may create a magnetic-based visual display cover arrangement with a sufficiently strong magnetic force attraction that may enable the magnetic-based visual display cover arrangement to withstand the drop test (from around 30-inch high onto a floor in an example), in an embodiment. In another example, a stronger magnetic force attraction may be required to enable the magnetic-based visual display cover arrangement to withstand more rugged conditions. To provide a stronger magnetic force, the manufacturers may tune the magnetic force attraction to increase the coupling between the enclosure-side magnetically attractable assembly and the screen-side magnetically attractable assembly.

As can be appreciated from the foregoing, the two arrangements may be independent arrangements attached together based on the magnetic attraction. Since the two arrangements are separable, buckling may be significantly reduced. In an example, as heat is emitted by the visual display screen, the two separate arrangements may be able to physically adjust based on the different thermal expansion coefficients. In other words, the difference in the thermal expansion coefficients may no longer cause buckling since one arrangement may adjust itself without negatively impacting the other arrangement.

Although the enclosure-side magnetically attractable assembly and the screen-side magnetically attractable assembly are independent separable assemblies, the two assemblies are visually integrated and are assembled by the manufacturers to be visually view as a single unit by the users. In other words, the magnetic-based visual display cover arrangement does not includes unsightly screws or glue or any other screen-to-enclosure attachment mechanism to keep the screen-side magnetically attractable assembly attached to the enclosure-side magnetically attractable assembly during use.

In an embodiment of the invention, the screen-side magnetically attractable assembly may include a set of alignment pins to enable self-alignment when the screen-side magnetically attractable assembly couples with the enclosure-side magnetically attractable assembly. In an example, the ferrous-based cover arrangement may include a set of alignment pins that enables self-alignment when the ferrous-based cover arrangement is attached to the magnet-based monitor arrangement. In an embodiment, the set of alignment pins may be made from non-ferrous materials and may be distributed inside the set of ring bands. Self-alignment may occur when the set of alignment pins is inserted into a set of cavities located on the enclosure.

The features and advantages of the present invention may be better understood with reference to the figures and discussions that follow.

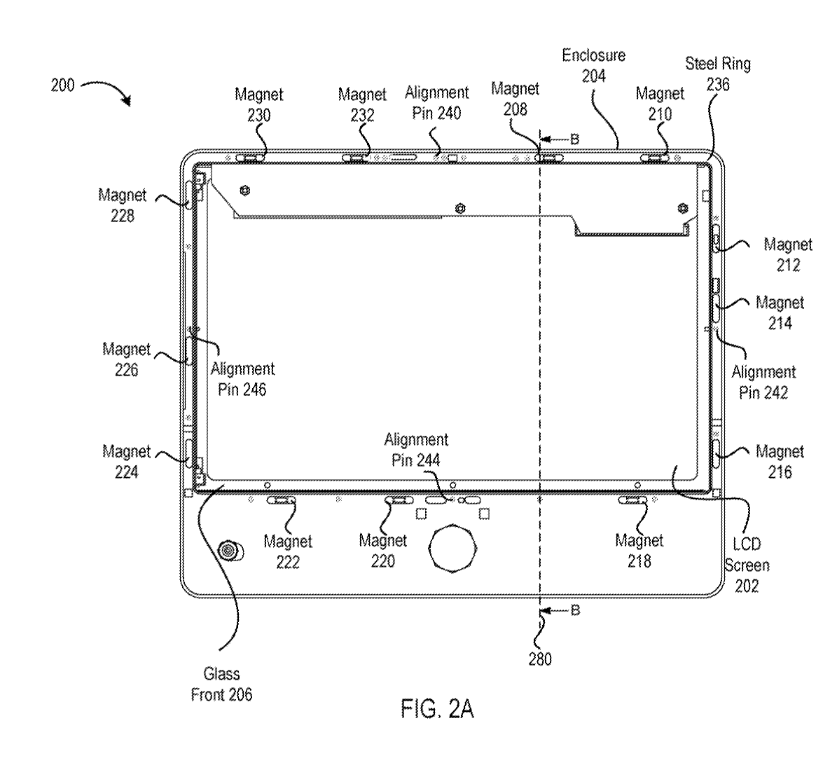

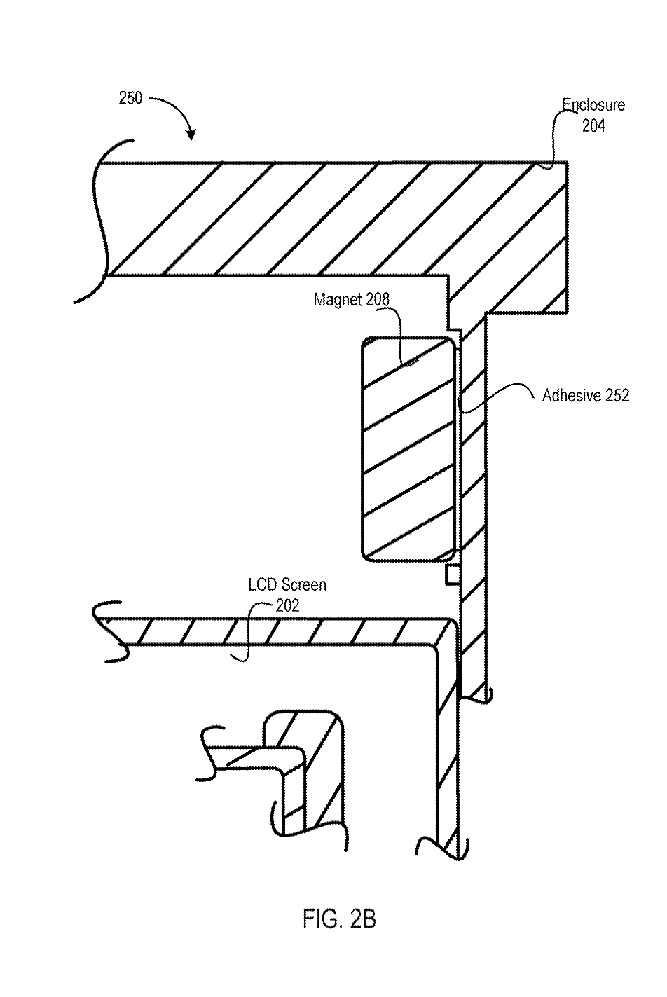

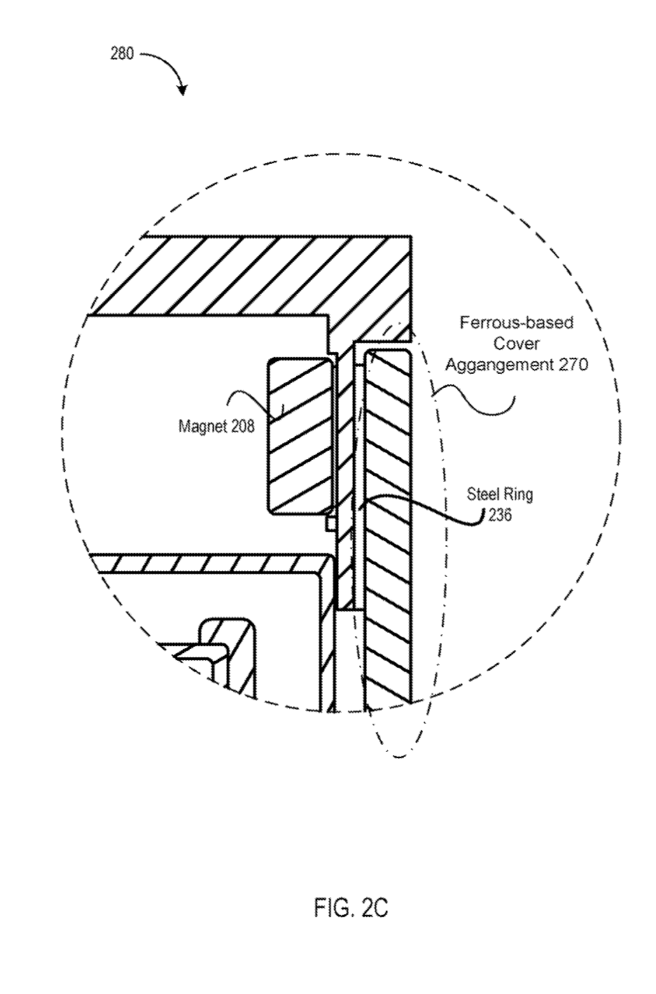

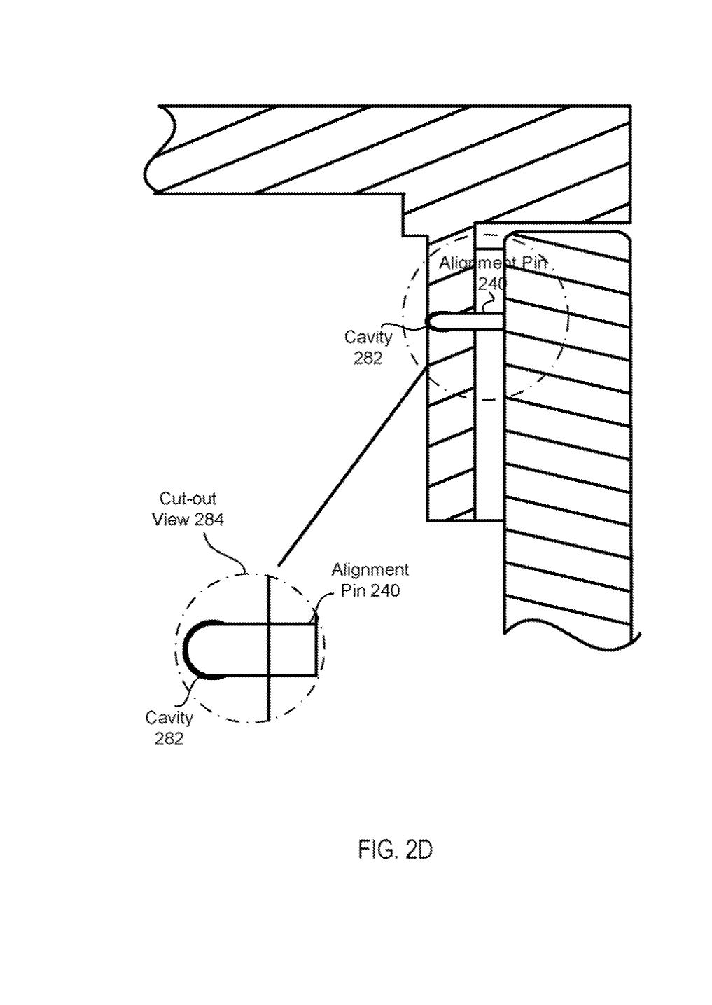

FIG. 2A shows, in an embodiment of the invention, a simple diagram illustrating a magnetic-based visual display cover arrangement 200. Magnetic-based visual display cover arrangement 200 may include an enclosure-side magnetically attractable assembly. The enclosure-side magnetically attractable assembly may include a visual display screen, such as an LCD screen 202 enclosed by an enclosure 204. Magnetic-based visual display cover arrangement 200 may also include a screen-side magnetically attractable assembly. The screen-side magnetically attractable assembly may be a non-opaque screen, such as a glass front 206, which may be located on top of LCD screen 202.

Unlike the prior art, the method for attaching glass front 206 to enclosure 204 is not via an unattractive method, such as trapping, or a method that may cause buckling, such as applying adhesive. Instead the force that is being applied to hold glass front 206 to enclosure 204 is a magnetic force. To create the magnetic force a set of magnets (208, 210, 212, 214, 216, 218, 220, 222, 224, 226, 228, 230, and 232) may be placed around enclosure 204. As can be appreciated from the foregoing, any number of magnets may be utilized without departing from the present invention. For example, even though thirteen magnets are shown in FIG. 2A, embodiments of the invention are not limited to a specific number of magnets. Instead, the number of magnets that may be employed to create the magnetic force may be based on the manufacturer's configuration preferences. In an example, by increasing/decreasing the number of magnets, the manufacturer may increase/decrease the strength of the magnetic force,

In an embodiment, the thickness, size and shape of the magnet may depend upon a manufacturer's configuration preferences. In an example, the magnet may be thicker if the manufacturer wants to create a stronger magnetic force field. In another example, the size of the magnet may be smaller if the manufacturer wants to create a weaker magnetic field. In yet another example, the magnet may be circular, triangular, rectangular, and the like.

In an embodiment, the set of magnets may be attached to enclosure 204 via an adhesive, as shown in FIG. 2B. FIG. 2B shows, in an embodiment of the invention, a cross-sectional view of a magnet-based monitor arrangement. A magnet-based monitor arrangement 250 may include enclosure 204 surrounding LCD screen 202. Located behind enclosure 204 may be a set of magnets. As can be appreciated from the foregoing, a non-ferrous material, such as adhesive 252 may be utilized to bond the set of magnets to enclosure 204. In an example, magnet 208 is bonded to enclosure 204 via adhesive 252.

In an embodiment, both enclosure 204 and adhesive 252 are made from non-ferrous materials to minimize the interference in the magnetic force field that may be generated by the set of magnets. In an example, adhesive 252 may be an epoxy, such as glue. Also, enclosure 204 may be made from anon-ferrous material, such as aluminum.

Those skilled in the art are aware that a magnet is usually attracted to ferrous materials, such as steel, iron, and the like. Referring hack to the FIG. 2A, magnetic-based visual display cover arrangement 200 may also include a ferrous-based cover arrangement. A ferrous-based cover arrangement may include a non-opaque screen, such as glass front 206, with a ring band, such as a steel ring 236. As can be appreciated from the foregoing, any non-opaque screen may be utilized as a cover for LCD screen 202. Examples of non-opaque screens include clear or colored or polarized screens. The screens themselves may be made of glass or plastic, for example. As also can be appreciated, the ring band may be made from any ferrous material capable of attracting the magnetic force field of the set of magnets. Examples of ferrous materials may include, but are not limited to, steel and iron.

In an embodiment, the thickness and shape of the ring band may depend upon a manufacturer's configuration preferences. In an example, the ring band may be thicker if the manufacturer wants to create a stronger attraction to couple with the set of magnets. In another example, the ring band may be circular, triangular, rectangular, and the like.

In an embodiment, the number of ring bands in the ferrous-based cover arrangement may also be varied based on a manufacturer's design preferences. In an implementation, a ring band may surround the glass front, as previously mentioned. In another implementation, a set of ring bands may be comprised of steel rings strategically positioned at different locations toward the edge of each side of the glass front. In other words, the set of ring bands may be strategically positioned so that coupling may occur between the set of ring bands and the set of magnets in the magnet-based monitor arrangement, as shown in FIG. 2C.

FIG. 2C shows, in an embodiment of the invention, a simple cross-sectional view of the coupling between magnet-based monitor arrangement 250 and ferrous-based cover arrangement 270 (which is a cut-out view of FIG. 2A at line 280). As can be seen, magnet-based monitor arrangement 250 is attached to ferrous-based cover arrangement 270. The two separable arrangements are held together by the attraction force between the set of magnets (such as magnet 208) and steel ring 236. Due to the sheer strength of the attraction, the ferrous-based cover arrangement 270 may not be dislodged from magnet-based monitor arrangement 250 due to normal everyday usage. In an embodiment, the attraction between the set of magnets aid the ring band is strong enough to pass a drop test (from around 30-inch high onto a floor in an example).

Although the attraction force between the set of magnets and steel ring 236 may have sufficient attraction to prevent the two arrangements from separating through normal usage, the attraction force may be weak enough to enable the two arrangements to be separated for maintenance. For example, the attraction between the steel ring and the set of magnets may be modulated to be strong enough to keep the two arrangements from separating in normal use yet weak enough in order to enable a suction cup to be utilized to remove the glass front from the LCD screen for servicing, such as replacing the glass front.

As mentioned, the tension strength may be sufficiently weak in order to enable the two arrangements to be independent from one another, thereby minimizing buckling. Unlike the adhesive arrangement in the prior art, the different thermal expansion coefficient in each of the arrangements may no longer cause buckling since the magnetic-based visual display cover arrangement may be comprised of two separable arrangements.

As can be appreciated from the foregoing FIG. 2C, the magnetic-based visual display cover arrangement is a visually integrated assembly. In other words, even though the two magnetically attractable assemblies are separable, the magnetic-based visual display arrangement is configured to be assembled in a manner that is visually viewable as a single unit. In other words, the magnet-based monitor arrangement and the ferrous-based cover arrangement are held together by fixtures that are hidden from view. Thus, the magnetic-based visual display cover arrangement may provide an elegant solution in that a protective cover for LCD screen 202 is provided without compromising a user's need to provide his own personal stamp to what some may view as an impersonal commodity.

Referring back to FIG. 2A, ferrous-based cover arrangement 270 may also include a set of alignment pins (240, 242, 244, and 246). In an embodiment, an alignment pin may be positioned on each side of glass front 206. In another embodiment, the set of alignment pin may be positioned within steel ring 236. To prevent the set of magnets from coupling with the set of alignment pin, the set of alignment pin may be made from a non-ferrous material, in an embodiment.

As can be appreciated from the foregoing, the size of each alignment pin may vary depending upon a manufacturer's configuration requirements. However, the alignment pin may be smaller than steel ring 236. In an embodiment, set of alignment pins may be utilized to enable ferrous-based cover arrangement 270 to self-align with magnet-based monitor arrangement 250, as shown in FIG. 2D.

FIG. 2D show, in an embodiment of the invention, a simple cross-sectional view of alignment between the magnet-based monitor arrangement aid the ferrous-based cover arrangement. As can be appreciated from the foregoing, set of alignment pins on glass front 206 may coupled with a set of cavities on enclosure 204. In an example, alignment pin 240 may be inserted into cavity 282 of enclosure 204. In an embodiment, cavity 282 may be slightly larger man alignment pin 240 to enable alignment pin 240 sufficient room to adjust itself to prevent buckling (as shown in cut-out view 284).

As can be appreciated from the foregoing, the magnetic-based visual display cover arrangement may be implemented based on a magnetic attraction between a monitor arrangement and a cover arrangement. Besides the embodiments described above (i.e., a ferrous-based cover arrangement attached to a magnet-based monitor arrangement), other arrangements may also be implemented. In embodiments of the invention, a magnetic-based visual display cover arrangement may be a ferrous-based monitor arrangement attached to a magnet-based cover arrangement. In another embodiment of the invention, a magnetic-based visual display cover arrangement may be a magnet-based monitor arrangement attached to a magnet-based cover arrangement. As can be appreciated from the foregoing, the disposition of the magnets may vary depending upon a manufacturer's configuration preference.

As previously mentioned, the magnet-based cover arrangement may be implemented as a ferrous-monitor to magnet-cover arrangement. In an embodiment of the invention, a magnet-based cover arrangement may include a set of magnets attached to a non-opaque screen. Similar to the magnet-based monitor arrangement, the magnet-based cover arrangement may be dispersed at different locations around the edges of the non-opaque screen. In an embodiment, the set of magnets may be affixed to the non-opaque screen by applying adhesive. To bide the set of magnets, non-opaque screen may employ a darker pattern around the edges of the non-opaque screen, in an embodiment. In another embodiment, the set of magnets may be enclosed within a non-ferrous cover that may be affixed to the non-opaque screen.

In an embodiment of the invention, the magnet-based cover arrangement is attracted to the ferrous characteristic of the ferrous-based monitor arrangement. Similar to the ferrous-based cover arrangement, the ferrous-based monitor arrangement may include a set of ring bands attached to an enclosure, in an embodiment. The set of ring bands may be discretely hidden from view by being affixed to the inside of the enclosure. In an embodiment, the set of ring bands may be a single ring band. In another embodiment, the set of ring bands may be a plurality of small ring bands dispersed along the outer edges of the enclosure.

Similar to the previously mentioned ferrous-cover to magnet-monitor arrangement, the ferrous-monitor to magnet-cover arrangement may be coupled to one another due to the magnetic attraction between the set of magnets and the set of ring bands. Thus, to ensure a tight coupling, the set of rings bands may have been strategically positioned in order to be aligned with the set of magnets when the magnet-based cover arrangement is attached to the ferrous-based monitor arrangement.

As previously mentioned, the magnet-based cover arrangement may be implemented as a magnet-to-magnet arrangement. In embodiments of the invention, a magnetic-based visual display cover arrangement may also be a magnet-based monitor arrangement attached to a magnet-based cover arrangement. Those skilled in the arts are aware that a magnet may be attracted to the opposite pole of another magnet. In an example, the north pole of a magnet is attracted to the south pole of another magnet. A well-known implementation of this principal may be observed by watching a train set. For example, a first rail car has a magnet attached to each end of the rail car. The magnet attached to the front end may have the north pole facing outward and the magnet attached to the back end may have the south pole facing outward. Similarly, a second rail car may have the same arrangement. When the front end of the second rail car is within close proximity to the back end of the first rail car, the magnetic attraction between the two opposite poles enable coupling to occur between the first and second rail cars.

The same opposite pole attraction principal may be applied in creating a magnet-based cover arrangement. To create the magnetic attraction, the magnet pole for each magnet attached to a non-opaque screen may be opposite from that of the magnet pole for each magnet attached to an enclosure. Thus, a tight coupling may be created preventing the magnet-based cover arrangement from being dislodged from the magnet-based monitor arrangement.

As can be appreciated from the foregoing, one or more embodiments of the present invention provide for a magnetic-based visual display cover arrangement which is comprised of two separable arrangements. By being separable, buckling is substantially reduced. Also, the two separable arrangements are made from readily available inexpensive materials. With the magnetic-based visual display cover arrangement, a monitor arrangement may be protected and at the same time, the decorative feature of the non-opaque screen may be displayed advantageously.

While this invention has been described in terms of several preferred embodiments, there are alterations, permutations, and equivalents, which fall within the scope of this invention. Although various examples are provided herein, it is intended that these examples be illustrative and not limiting with respect to the invention.

Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A display housing for housing a display monitor, comprising:
an enclosure for enclosing at least a portion of said display monitor, said enclosure being non-ferrous and having a first side and a first magnetically attractable assembly coupled to said enclosure; and
a non-opaque screen having a second side and a second magnetically attractable assembly coupled to said non-opaque screen such that when said second side of said non-opaque screen is mated with said first side of said enclosure, a magnetic attraction force is created between said first magnetically attractable assembly and said second magnetically attractable assembly, wherein said first magnetically attractable assembly and said second magnetically attractable assembly are configured such that said magnetic attraction force is sufficiently strong to hold said non-opaque screen to said enclosure during use.

2. The display housing of claim 1 wherein said display monitor is a LCD (liquid crystal display) screen.

3. The display housing of claim 1 wherein said first magnetically attractable assembly represents a set of magnets.

4. The display housing of claim 1 wherein said second magnetically attractable assembly represents a ferrous component.

5. The display housing of claim 4 wherein said ferrous component represents a set of ring bands, said set of ring bands being at least a single steel ring.

6. The display housing of claim 1 wherein said second magnetically attractable assembly represents a set of magnets.

7. The display housing of claim 1 wherein said first magnetically attractable assembly representing a ferrous component, said ferrous component including at least one ring band.

8. The display housing of claim 1 further comprising a set of alignment pins configured to enable self-alignment between said non-opaque screen and said enclosure.

9. The display housing of claim 1 wherein said first magnetically attractable assembly and said second magnetically attractable assembly represent magnets.

10. A display housing for housing a display monitor, comprising:
an enclosure for enclosing at least a portion of said display monitor, said enclosure being non-ferrous and having a first side facing toward a display viewing position and a first magnetically attractable assembly coupled to said enclosure, said first magnetically attractable assembly including at least one magnet; and
a non-opaque screen having a second side and a second magnetically attractable assembly coupled to said second side such that when said second side of said non-opaque screen is mated to said first side of said enclosure, a magnetic attraction force is created between said first magnetically attractable assembly and said second magnetically attractable assembly, said magnetic attraction force representing a force sufficiently strong to hold said non-opaque screen to said enclosure during use so as to eliminate a need for another screen-to-enclosure attachment mechanism to keep said non-opaque screen attached to said enclosure during said use, wherein said second magnetically attractable assembly includes at least one ferrous portion and said second side represents a side facing away from said display viewing position when said non-opaque screen is mated to said enclosure.

11. The display housing of claim 10 wherein said display monitor is a LCD (liquid crystal display) screen.

12. The display housing of claim 10 wherein said first magnetically attractable assembly represents a set of magnets.

13. The display housing of claim 10 wherein said ferrous portion represents a set of ring bands.

14. The display housing of claim 13 wherein said set of ring bands represents a single steel ring.

15. The display housing of claim 10 further comprising a set of alignment pins configured to enable self-alignment between said non-opaque screen and said enclosure.

16. A display housing for housing a display monitor, comprising:
a non-ferrous enclosure for enclosing at least a portion of said display monitor, said enclosure being non-ferrous and having a first side;
a non-opaque screen having a second side;
first magnetically attractable means coupled to said enclosure; and
second magnetically attractable means coupled lo said non-opaque screen such that when said second side of said non-opaque screen is mated with said first side of said enclosure, a magnetic attraction force is created between said first magnetically attractable means and said second magnetically attractable means, wherein said first magnetically attractable means and said second magnetically attractable means are configured such that said magnetic attraction force is sufficiently strong to hold said non-opaque screen to said enclosure during use.

17. The display housing, of claim 16 wherein said display monitor is a LCD (liquid crystal display) screen.

18. The display housing of claim 16 wherein said first magnetically attractable means represents a set of magnets and said second magnetically attractable means includes at least one ferrous component.

19. The display housing, of claim 16 wherein said second magnetically attractable means represents a set of magnets and said first magnetically attractable means includes at least one ferrous component.

20. The display housing of claim 16 wherein said first magnetically attractable means includes at least a first magnet and said second magnetically attractable means includes at least a second magnet.
